(19) United States
(12) Patent Application Publication
(10) Pub. No.: US 2002/0046173 A1
(43) Pub. Date: Apr. 18, 2002

(54) Method, apparatus and system to facilitate delivery of goods and services to secure locations

(76) Inventor: Stephen J. Kelly, Marion, IA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/861,173

(22) Filed: May 18, 2001

Related U.S. Application Data
(60) Provisional application No. 60/205,782, filed on May 19, 2000.

(51) Int. Cl. G06F 17/60

(52) U.S. Cl. 705/50

(57) ABSTRACT

A delivery system includes a secured area having an entrance; a lock securing the entrance to the secured area and responsive to at least a first delivery agent access digital key to provide access to the secured area; a customer communications device configured to place requests for at least one of goods and services and to transfer the first delivery agent access digital key; a deliverer communications device configured to receive the requests and the delivery agent access digital key from the customer communications device; and a deliverer handheld communications device configured to transmit the delivery agent access digital key to the lock to access the secured area.

### CROSS-REFERENCE TO RELATED APPLICATION

This application claims the benefit of U.S. Provisional Application No. 60/205,782, filed on May 19, 2000.

### TECHNICAL FIELD

The following disclosure relates generally to the ordering and delivering of goods and/or services.

### BACKGROUND OF THE INVENTION

In general, the secure delivery of a product and/or service requires either a person to be present to receive the product, or that the customer have a secure location where the delivery agent can deposit the ordered goods or provide the ordered services. This is particularly a problem for the secure home delivery of goods and/or services, given the work schedules of many customers.

Access to secure areas, such as boxes, vaults, porches, sheds, garages, homes, etc. typically requires a key. Mechanical keys have a number of drawbacks. For example, mechanical keys may be lost or stolen. Mechanical keys are also difficult to pass to a delivery agent, particularly where commerce is performed at a distance, such as via the telephone or the Internet. It is also difficult to limit the reproduction of mechanical keys, and to retrieve the key after use to prevent the key from being used at the wrong times.

A number of electronic key solutions have been proposed to solve some of these problems, including the use of key pads, pass cards and radio frequency (“RF”) keys. Typically, these proposed solutions address only some of the problems. For example, the use of a key pad requires an authorization key to be memorized, and the consequent risk that the delivery agent will forget the authorization key and not be able to complete the delivery. If the delivery agent writes the authorization key down, there is the risk that the authorization key will be lost or stolen. Similarly, pass cards can be lost or stolen. In each instance, there is a risk that the key will be used inappropriately at time before and/or after the requested delivery. Additionally, these proposed solutions often include costly retrofits, typically requiring the installation of an electrical line between the customer's home and the secure area.

### SUMMARY OF THE INVENTION

In one aspect, a delivery system includes a secured area having an entrance; a lock securing the entrance to the secured area and responsive to at least a first delivery agent access digital key to provide access to the secured area; a customer communications device configured to place requests for at least one of goods and services and to transfer the first delivery agent access digital key; a deliverer communications device configured to receive the requests and the delivery agent access digital key from the customer communications device; and a deliverer handheld communications device configured to transmit the delivery agent access digital key to the lock to access the secured area.

In another aspect, a customer delivery system includes a lock for securing an entrance to a secured area, the lock responsive to at least a first customer access digital key and to at least a first delivery agent access digital key to provide access to the secured area; and a customer communications device selectively couplable to a business to transfer the first delivery agent access digital key and a request for at least one of goods and services to the business, the customer communications device also couplable to the lock to set at least the first delivery agent access digital key to a defined value different from a defined value of the first customer access digital key and any other of the delivery agent and the customer access digital keys.

In a further aspect, a business delivery system includes a business communications device selectively couplable to receive a delivery agent access digital key and a request for at least one of goods and services from a customer communication device; and a handheld device couplable to transfer the delivery agent access digital key to a lock to gain access to a secure area.

In yet another aspect, a method of facilitating the delivery of goods and services includes receiving a request for at least one of goods and services; receiving a first delivery agent access digital key; entering the first delivery agent access digital key into a lock controlling access to a secured area; gaining access to the secured area; and delivering the requested goods and services to the secured area.

In yet a further aspect, a method of facilitating the delivery of goods and services includes transmitting a request for at least one of goods and services to a business; transmitting a first delivery agent access digital key to the business; and configuring a lock controlling access to a secured area to provide access to the secured area in response to receipt of at least the first delivery agent access digital key.

In yet even a further aspect, an automated ordering method includes displaying information identifying at least one of goods and services available for order; in response to a single action transmitting a request for at least a selected one of the goods and services along with a delivery agent access digital key for gaining access to a secure area; receiving the request and delivery agent access digital key; transmitting the delivery agent access digital key to gain access to a secure area; and delivering the requested goods and services to the secured area.

In yet another aspect, a client system for ordering goods and services includes a display component for displaying information identifying goods and services available for order; and a single-action ordering component that in response to a performance of a single action, sends a request to a server system to order at least a selected one of the available goods and services, the request including a delivery agent access digital key for gaining access to a secure area.

### BRIEF DESCRIPTION OF THE DRAWINGS

FIG. 1 is a schematic diagram of an order and delivery system for delivering requested goods and/or services to a secured area, such as a customer's home.

FIG. 2 is a schematic diagram showing a delivery agent computing device wirelessly communicating with an RF lock for use with the system of FIG. 1.

FIG. 3 is a flow diagram of showing a method of ordering and receiving goods and/or services by a customer according to one exemplary embodiment of the invention.

FIG. 4 is a flow diagram of showing a method of operation of a customer computing system according to one exemplary embodiment of the invention.

FIG. 5 is a flow diagram of showing the method of operation of a customer computing system according to another exemplary embodiment of the invention.

FIG. 6 is a flow diagram of showing the method of operation of a customer computing system according to a further exemplary embodiment of the invention.

FIG. 7 is a flow diagram of showing a method of operation of a business computing system according to one exemplary embodiment of the invention.

FIG. 8 is a flow diagram of showing a method of operation of the delivery agent communication device according to one exemplary embodiment of the invention.

FIGS. 9A, 9B and 9C are a flow diagram of showing a method of operation of the RF lock according to one exemplary embodiment of the invention.

### DETAILED DESCRIPTION OF THE INVENTION

Wireless data collection methods, systems and techniques are described in detail herein. In the following description, numerous specific details are provided, such as specific dimensions, protocols, frequencies, etc. to provide a thorough understanding of, and enabling description for, embodiments of the invention. One skilled in the relevant art, however, will recognize that the invention can be practiced without one or more of the specific details or with other dimensions, protocols, frequencies, etc. In other instances, well-known structures or operations are not shown, or not described in detail, to avoid obscuring aspects of the invention.

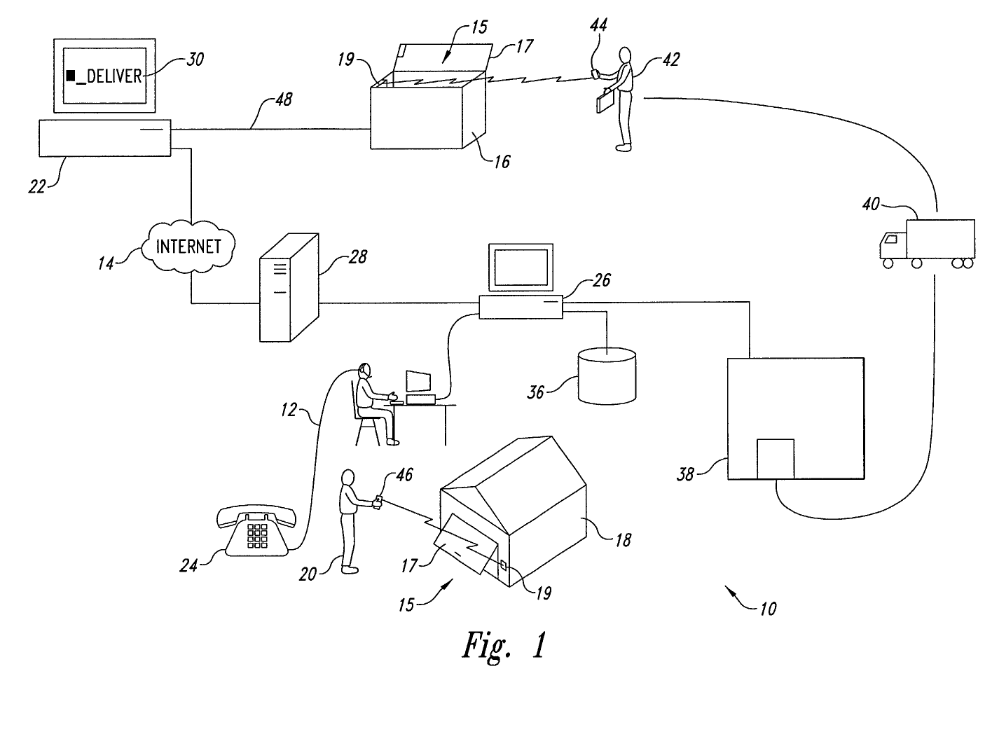

FIG. 1 shows an order and delivery system 10 for fulfilling orders for goods and/or services placed via a telecommunications device such as the public telephone system 12 or the Internet 14, and involving the delivery of the requested goods and/or services to a secured area such as a secured box 16, vaults, porch, shed, garage 18, home, or other secured area. Each of the secured areas 16, 18, includes an entrance 15, a door 17 selectively opening and closing the entrance 17 and a respective lock 19, that selectively provides access to the secured area 16, 18 through an entrance 17 in response to a key.

A customer 20 may place an order for goods or services, for example, via a customer computing system 22 or telephone 24. If the customer 20 places the order via the Internet, the order may be routed to a business computing system 26 by way of a business server such as the business Web server 28 that serves Web pages to a Web client executing on the customer computing system 22. The Web pages can include information about the available goods and/or services including, but not limited to price, style, size, color, make and/or model. The Web pages can also include forms for receiving order and/or delivery information from the customer, including, but not limited to, delivery address, billing address, billing authorization, and other contact information. The Web pages can also include a customer selectable graphical icon 30 that transmits an order along with a delivery agent access key in response to a single selection of the icon 30 by the customer 20.

If customer 20 places the order via the public telephone system 12, the order may be routed to the business computing system 26 by an account representative 32 using an account representative computing system 34, for example, by keying the order information into the account representative computing system 34.

The order and delivery system 10 may include one or more databases 36 coupled to the business computing system 26 for storing order information, account or customer information, and/or accounting information.

The order and delivery system 10 may also include a warehouse 38 or other storage facility from which orders are fulfilled. Orders may be accumulated and grouped geographically to reduce the costs associated with delivery. Orders can also be fulfilled to expedite delivery. Where the orders are for goods, fulfillment includes gathering some or all of the requested goods for shipment. Fulfillment may also include associating delivery and/or other information with the shipments. The business may fulfill the orders using the business's own personnel, or may contract out the fulfillment process.

The order and delivery system 10 may also include transportation 40 for moving the goods and/or person supplying the services to the secured area 16, 18. The transportation can take any of a variety of forms, including, but not limited to some or all of trucks, planes, boats, bicycles, and automobiles. The business may employ its own transportation or can rely on common carriers such as post offices, and/or parcel delivery services.

A delivery agent 42 makes the delivery to the secured area 16, 18. The delivery agent can have a delivery agent computing device 44 that stores and accesses information such as delivery information, order information, and/or route information. The delivery agent computing device 44 may also provide communications with the business, the customer 20 and/or with the lock 19. FIG. 1 shows the delivery agent 42 communicating with the lock 19 via the delivery agent computing device 44. As explained in detail below, the communications can include the wireless transmission of a delivery agent access key to the lock 19 to gain access to the secured area 16.

The customer 20 can have a customer access device 46 for communicating with the lock 19. For example, customer 20 can employ the customer access device 46 for wireless transmitting a customer access key to the lock 19 for gaining access to the secured area 18. The customer 20 can also communicate with the lock 19 using the customer computing system 22 via a wired or wireless communications connection 48, such as a network connection.

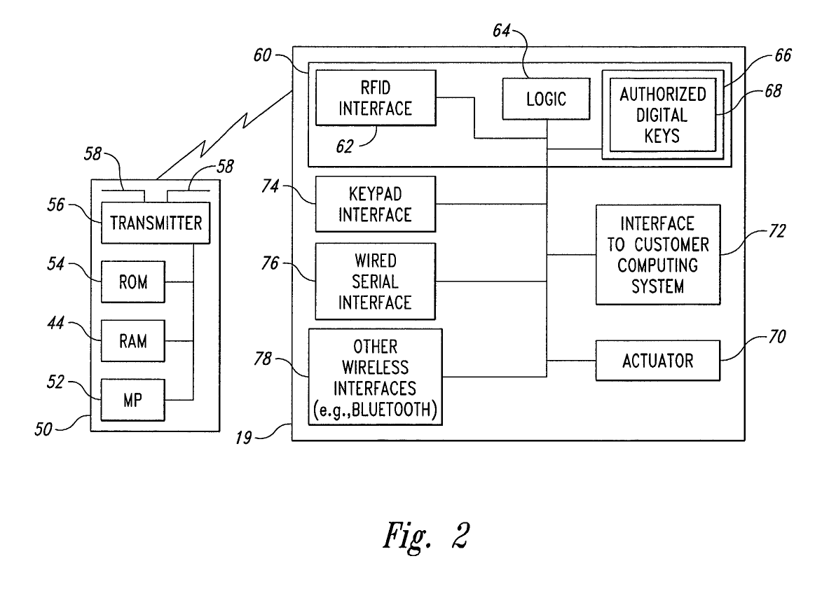

As shown in FIG. 2, the delivery agent computing device 44 may include a microprocessor 50 or other controller, a random access memory (“RAM”) 52 and a persistent memory such as a read only memory (“ROM”) 54. The RAM 52 and/or ROM 54 can contain instructions and data for controlling the operation of the microprocessor 50. The RAM 52 and/or ROM 54 can also include delivery, order and/or route related information. The delivery agent computing device 44 may also include a transmitter 56 and an antenna 58, controlled in response to the microprocessor 50. While omitted from FIG. 2 for clarity of illustration, the delivery agent computing device 44 may further include a receiver. Additionally, the delivery agent computing device 44 can include a global positioning system (“GPS”) receiver (not shown) for providing location information to the delivery agent 42 and/or the business.

The lock 19 can include a radio frequency identification (“RFID”) portion 60, such as an RFID tag, and an actuator. RFID tags are commonly known in the automatic data collection (“ADC”) field, for wirelessly storing and/or retrieving data. Active RFID tags carrying a power source, such as a battery. Passive RFID tags derive power from an RF interrogation signal generated by an interrogating device, such as the delivery agent computing device 44 (shown in detail in FIG. 2), or the customer access device 46. Use of a passive RFID tag eliminates the need to provide a power line to the lock 19, reducing the cost of installing the order and delivery system 10 and permitting the use of the order and delivery system 10 in remote locations without access to a dedicated power source.

The RFID portion 60 includes an RFID interface 62 typically in the form of an antenna, and logic 64 typically in the form of a semiconductor microchip. RFID tags are typically formed by depositing an antenna as a conductive trace on a thin sheet of insulating material such as mylar, and coupling a microchip to the antenna by way of a pair of leads. Common antenna forms for RFID tags include dipole antennas or a coil loop antennas. The microchip typically includes the logic 64 for controlling the device and memory 66 for storing data, such as authorized access keys 68.

The lock 19 includes an actuator 70 coupled to secure the door 17 across the entrance 15 to the secured area 16, 18 (FIG. 1). The actuator 70 can take any of a variety commonly known forms for securing the door 17 across the entrance 15, such as deadbolts, tumblers, and motors to name a few.

The lock 19 can also include a customer computing system interface 72 to provide communications between the RFID portion 60 of the lock 19 and the customer computing system 22. This permits the setting and disabling of delivery agent access keys, as well as customer access keys. This can also permit the transfer of information from the lock 19 to the customer computing system 22, such as order related information, for example an inventory, price list and/or invoice transmitted to the RFID portion 60 of the lock 19 by the delivery agent computing device 44.

Additionally, the lock 19 can include a variety of other interfaces for providing either unidirectional, or bi-directional communications. For example, a keypad interface 74 can permit access keys and other information to be transmitted to the lock by manual keying. A wired serial interface 76 permits access keys and other information to be transmitted to, and from, the lock 19 over an electrical or optical connection. For example, the lock 19 can function as a touch memory device. Touch memory devices are available from a number of sources such as Dallas Semiconductor of Dallas, Tex. The lock 19 can include other wireless interfaces 78, in addition to the RFID interface 62, such as a wireless interface suitable for use with the BLUETOOTH protocol. These additional interfaces 74, 76, 78 typically require a dedicated source of power, so may be less advantageous than the RFID interface 62.

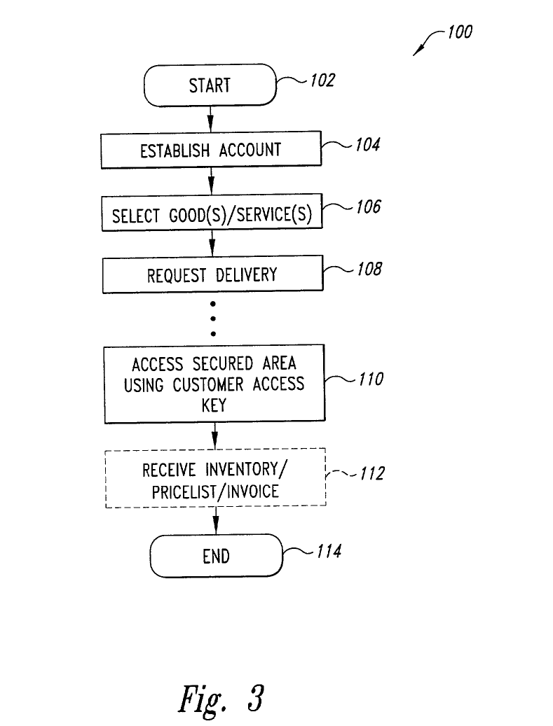

FIG. 3 shows a method 100 of ordering and receiving goods and/or services by the customer 20 employing the exemplary order and delivery system 10 of FIGS. 1 and 2, starting in step 102. In step 104, the customer 20 establishes an account with the business. For example, the customer 20 may provide customer account information such as customer identification information, billing information, and/or delivery information to the business through Web pages over the World Wide Web portion of the Internet 14. The customer 20 may simply provide a customer identifier and/or a password to establish the account where the customer 20 has previously provided customer account information to the business.

In step 106, the customer selects one or more goods and/or services. Again, the order and delivery system 10 can employ Web pages transmitted over the Internet 14 to provide the customer 20 with a display of the available goods and services and to receive the customer's selections. In step 108, the customer 20 requests delivery of the selected goods and/or services. For example, the customer 20 may select or otherwise activate a single delivery icon 30 (FIG. 1) to request delivery of the selected goods and/or services based on previously entered customer identification, billing and delivery information.

After a period of time, indicated by ellipses in the Figures, the customer 20 accesses the secured area 16, 18 in step 110. For example, the customer 20 may use the customer access device 46 to wirelessly transmit a customer access key to the lock 19 to gain access. Other methods such as keying the customer access key or transmitting the customer access key via a wired connection can also be employed, but may be less advantageous than employing the wireless transmission. A separate customer access key can be provide to each person having authority to act as the customer, for example, each family member may have a respective customer access key. Alternatively, a single customer access key can be shared by two or more trusted people. The customer access key can be periodically modified to prevent the customer access key from being stolen, or guessed. The customer access key can be frequently changed where the customer access key is stored in the customer access device 46 since no memorization is required by the customer 20. Once the customer 20 accesses the secured area, the customer can retrieve the requested goods or serviced components, if desired.

In optional step 112, the customer 20 may receive an inventory, price list, invoice or other information regarding the order. The customer 20 may compare the received goods and/or services to the received information to verify that the order was correctly fulfilled. The method 100 terminates in step 114.

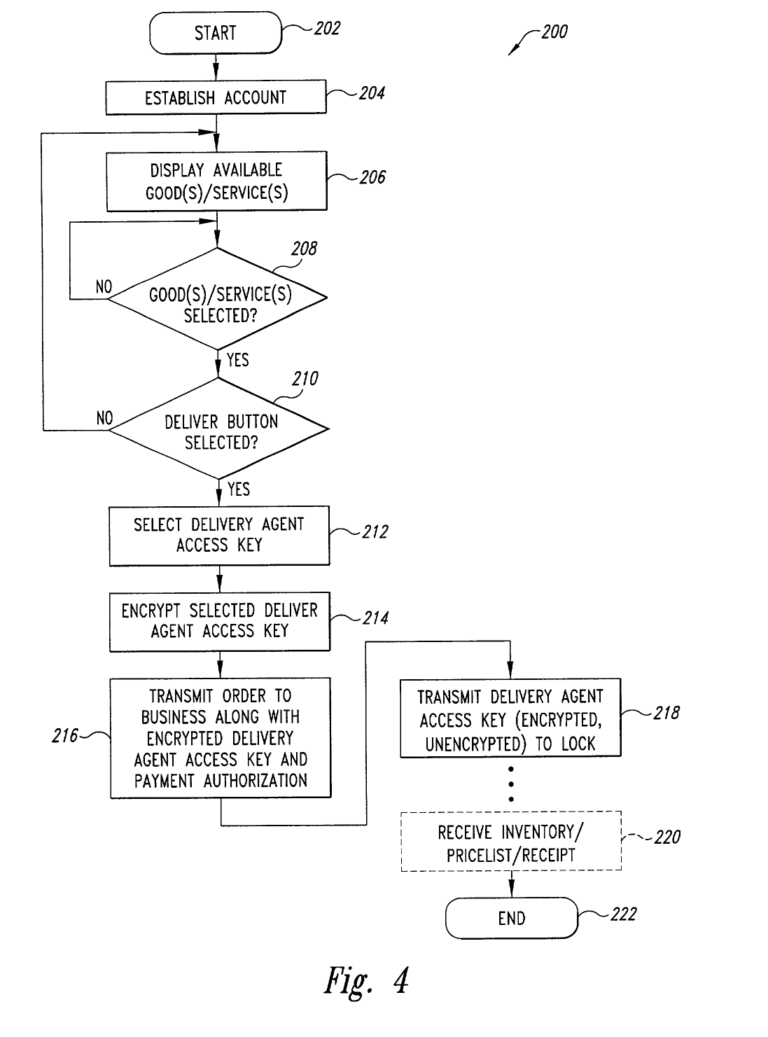

FIG. 4 shows one exemplary method 200 of operating the customer computing system 22 where the payment is authorized at the time of placing the order, starting in step 202. In step 204, the customer computing system 22 establishes the customer account, for example transmitting customer account information to the business via the Internet 14. In step 206, the customer computing system 22 display the available goods and/or services to the customer 20. For example, the customer computing system 22 may display one or more Web pages downloaded from the business's Web server 28.

In step 208, the client computing system 22 determines whether the customer 20 has selected goods and/or services. The client computing system 22 executes a wait loop, returning to step 208 until the customer selects goods or services. In step 210, the client computing system 22 determines whether the customer 20 has selected to have the goods and/or services delivered. If the customer 20 has not yet selected to have the goods and/or services delivered, the client computing system 22 returns to step 206 to allow the customer 20 to select additional goods and/or services to modify previous selections. If the customer 20 has selected to have the goods and/or services delivered, the client computing system 22 passes control to step 212.

In step 212, the client computing system 22 selects a delivery agent access key for the particular order. In step 214, the client computing system 22 encrypts the selected delivery agent access key using known encryption techniques, such as public-private key encryption. In step 216, the client computing system 22 transmits the order to business along with the encrypted delivery agent access key and payment authorization.

In step 218, the client computing system 22 transmits the selected delivery agent access key to the lock 19, either in encrypted or unencrypted form. This authorizes the selected delivery agent access key to provide access to the secured area 16, 18.

In optional step 220, the customer 20 may receive an inventory, price list, invoice or other information regarding the order. The customer 20 may compare the received goods and/or services to the received information to verify that the order was correctly fulfilled. The method 200 terminates in step 222.

FIG. 5 shows another exemplary method 224 of operating the customer computing system 22 where the payment is authorized after receiving the order, starting in step 202. This alternative embodiment, and those alternative embodiments and other alternatives described herein, are substantially similar to previously described embodiments, and common acts and structures are identified by the same reference numbers. Only significant differences in operation and structure are described below.

The customer computing system 22 executes steps 202-214 in the fashion describe above in reference to method 200 of FIG. 4. In step 226, the customer computing system 22 transmits the order to business along with the encrypted delivery agent access key, but without a payment authorization. The customer computing system 22 then transmits the delivery agent access key to the lock 19 in step 218, as described above.

After a period of time, indicated by ellipses in the Figures, the customer computing system 22 receives notification of the delivery agent 42 accessing the secured area 16, 18 in step 228. In step 232, the customer computing system 22 transmits the payment authorization to the business, for example, as an encrypted message sent via the Internet 14.

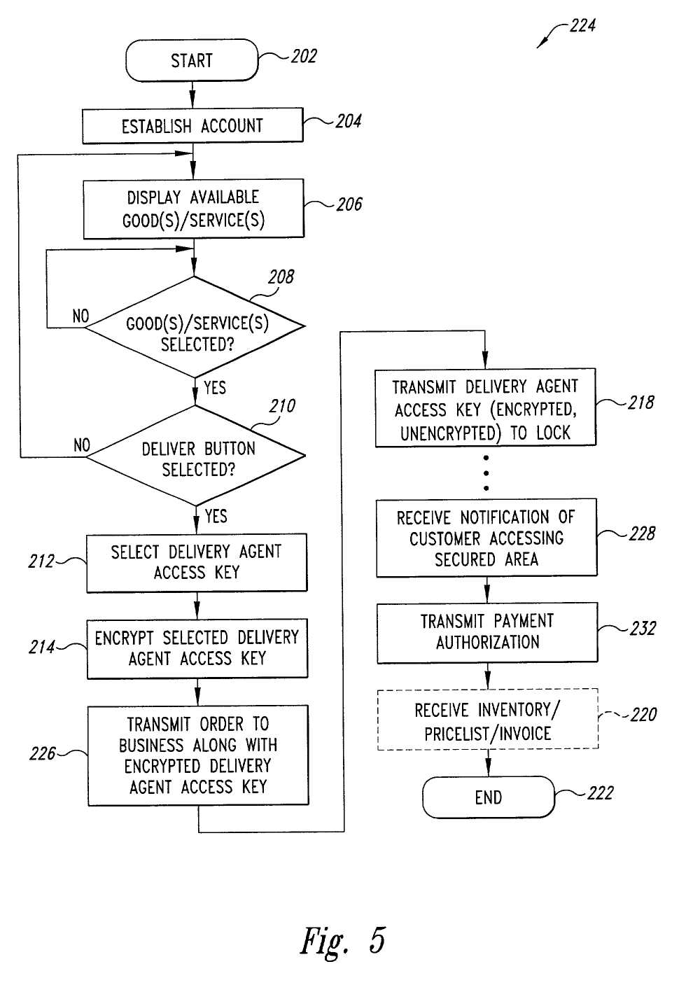

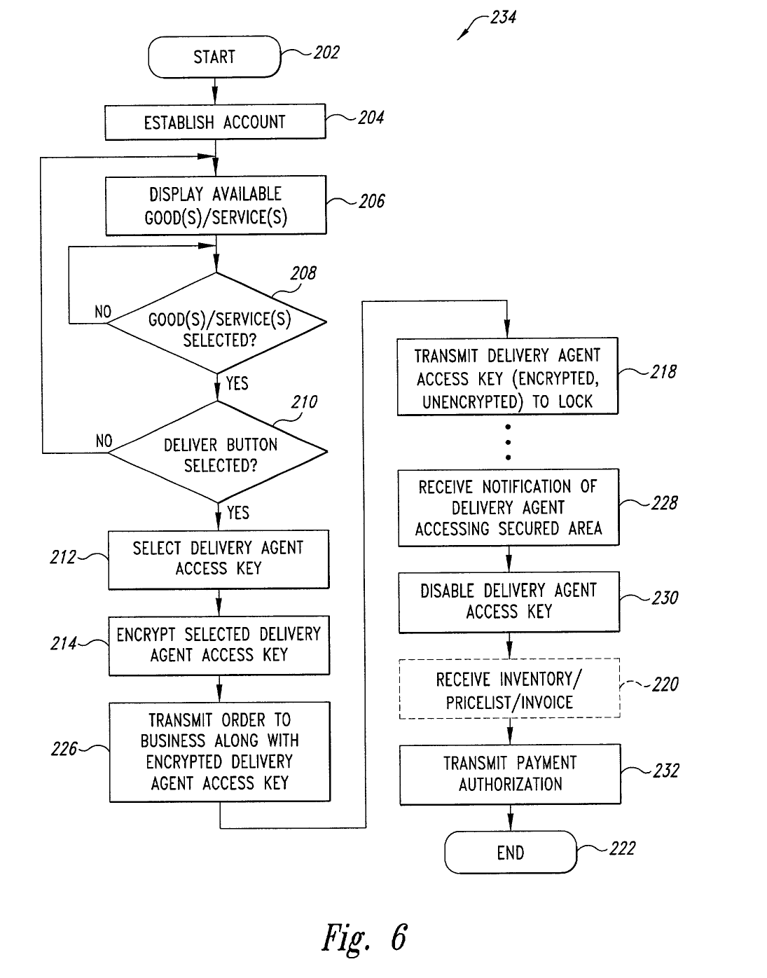

FIG. 6 shows another exemplary method 234 of operating the customer computing system 22 where the payment is authorized after receiving the order and the delivery agent access key is disabled following access to the secured area 16, 18 by the delivery agent 42, starting in step 202. This alternative embodiment is substantially similar to previously described embodiments, and common acts and structures are identified by the same reference numbers. Only significant differences in operation and structure are described below.

The customer computing system 22 executes steps 202-214 and 226, 218 and 228 in the fashion describe above in reference to method 224 of FIG. 5.

In response to the notification of the delivery agent 42 accessing the secured area 16, 18, the client computing system 22 automatically disables the delivery agent access key in step 230. For example, the client computing system 22 may transmit an appropriate command to the lock 19 over the communications connection 48.

In step 232, the customer computing system 22 transmits the payment authorization to the business, for example, as an encrypted message sent via the Internet 14.

In the method 234, the optional step of receiving the inventory, price list and/or invoice 220 occurs before the step of transmitting the payment authorization 232. This allows the customer 20 to review the inventory, price list and/or invoice, and/or to verify the received goods and/or services against the inventory, price list and/or invoice before authorizing the payment. Thus, the payment authorization in the method 234 may require a specific input by the customer 20, as opposed to the payment authorization of the method 224, which may be automatically generated by the customer computing system 22 in response to the notification. Many business may find automatic generation of the payment authorization advantageous, while many customers may find the assurance of personally verifying the order fulfillment prior to generation of the payment authorization advantageous.

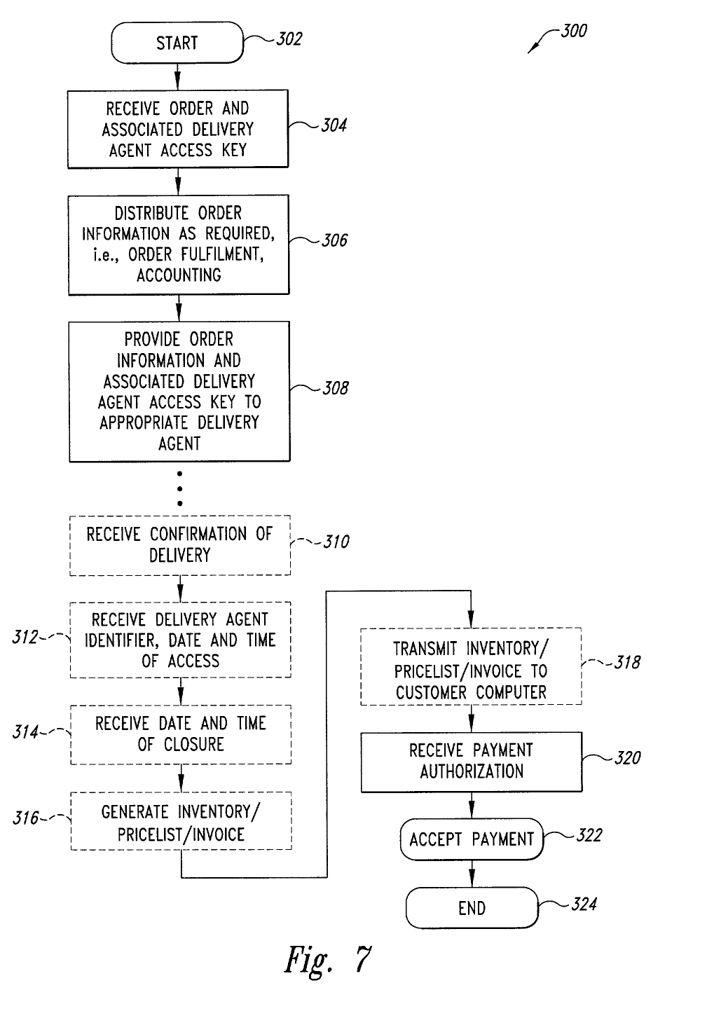

FIG. 7 shows an exemplary method 300 of operating the business computing system 26, starting in step 302. In step 304, the business computing system 26 receives an order and an associated delivery agent access key. The business computing system 26 may receive the order and delivery agent access key from the customer computing system 22 via the Internet 14, or from the customer telephone 24 by way of the public telephone system 12.

In step 306, the business computing system 26 distributes the order information as required by the particular business operations. For example, the business computing system 26 may transmit the order information to a fulfillment department, either as an electronic file or printed paper file. The fulfillment department can gather and/or package the order for delivery, for example picking items stored in the warehouse 38. The business computing system 26 may also transmit order information to an accounting department, for tracking payments and accounts receivables, as well as other accounting related tasks. The business computing system 26 may also transmit the order information to an inventory department, to perform inventory analysis, to ensure sufficient inventory is always available to fulfill orders. The business computing system 26 may also transmit the order information to a marketing department, for analysis and to create marketing strategies. The business computing system 26 may further provide the order information to a customer relations department, to update customer relations as appropriate.

In step 308, the business computing system 26 provides the order information and the associated delivery agent access key to the appropriate delivery agent. While this may consist of simply passing the order information and the associated delivery agent access key to the delivery agent 42, either orally or in writing, this will preferably consist of downloading the order information and the associated delivery agent access key to the delivery agent computing device 44. Downloading the order information and the associated delivery agent access key to the delivery agent computing device 44 address many of the concerns raised in the background section of this specification.

In optional step 310, the business computing system 26 receives confirmation of the delivery. Confirmation can come from the delivery agent computing device 44 via an RF transmission, or from the customer computing system 22, for example via the Internet 14. In optional step 312, the business computing system 26 receives the delivery agent identifier, the date and/or the time of that access to the secured area 16, 18 was granted to the delivery agent 42. The delivery agent identifier and/or access date and time can come from the delivery agent computing device 44 via an RF transmission, or from the customer computing system 22, for example via the Internet 14. In optional step 314, the business computing system 26 receives the date and/or time of closure of the entrance 15 to the secured area 16, 18. The closure date and time can come from the delivery agent computing device 44 via an RF transmission, or from the customer computing system 22, for example via the Internet 14.

In step 316, the business computing system 26 generates the inventory, price list and/or invoice. In step 318, the business computing system 26 transmits the inventory, price list and/or invoice to the customer 20, for example via the Internet 14 or via traditional postal carrier (not shown). In step 320, the business computing system 26 receives payment authorization from the customer, for example via the Internet 14, the public telephone system 12 and/or traditional postal carrier. In step 322, the business computing system 26 accepts payment, for example accepting a funds transfer, or registering a debit to charge account or a debit account. The method 300 terminates in step 324.

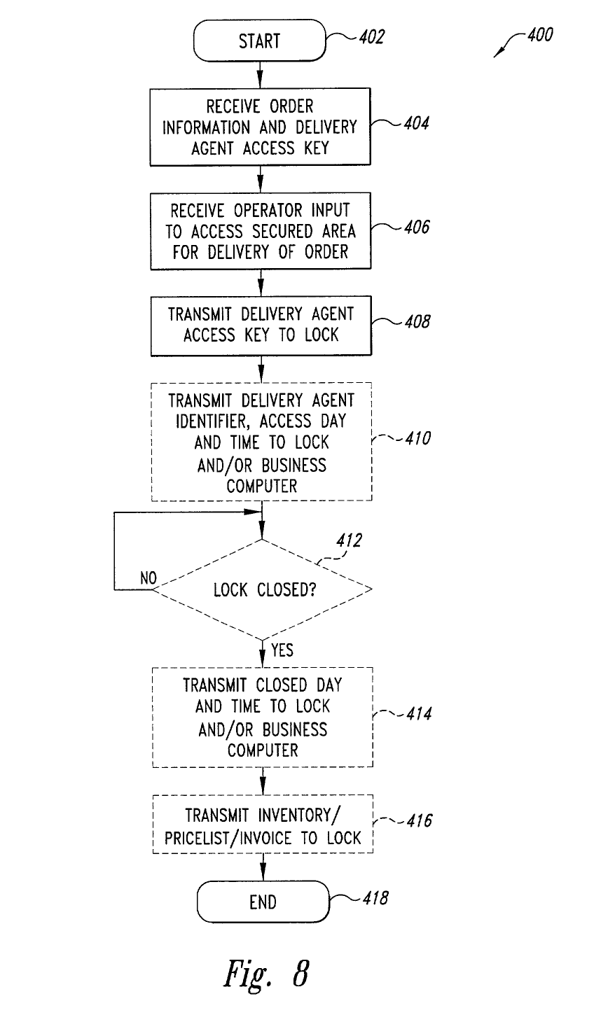

FIG. 8 shows a method 400 of operating the delivery agent computing device 44, starting in step 402. In step 404, the delivery agent computing device 44 receives the order information and the associated delivery agent access key. The delivery agent computing device 44 can receive the order information and the associated delivery agent access key from the business computing system 26, via a wired or wireless communications channel. In the typical use, the delivery agent computing device 44 will receive the order information and the associated delivery agent access key for each of the deliveries on the delivery agent's route. The delivery agent computing device 44 may also receive route information for all of the scheduled deliveries, such as specific directions and/or a map.

In step 406, the delivery agent computing device 44 receives operator input, such as selection of a trigger, switch or icon, to access a secured area 16, 18. In step 408, the delivery agent computing device 44 transmits the delivery agent access key to the lock 19. For example, the delivery agent computing device 44 may produce an RFID interrogation signal based on the delivery agent access key. Also, for example, the delivery agent computing device 44 may produce a signal on a serial output line based on the delivery agent access key. Additionally for example, the delivery agent computing device 44 may produce a wireless signal employing the BLUETOOTH protocol based on the delivery agent access key. As a further example, the delivery agent computing device 44 may simply display the delivery agent access key on a display of the delivery agent computing device, allowing the delivery agent 42 to manually key the delivery agent access key into the lock 19 using the keypad interface 74 (FIG. 2).

In optional step 410, the delivery agent computing device 44 transmits the delivery agent identifier, day and/or time of access to either the lock 19 and/or the business computing system 26. Placing the time keeping responsibility on the delivery agent computing device 44 eliminates the need to include a clock and power source for the clock on the lock 19. Alternatively, the time keeping responsibility can belong to the client computing system 22, which can transmit the current date and time in response to a signal received from the lock 19 over the communications connection 48. However, many business may not wish to rely on the customer computing system 22 for date and time information, since the date and time on the customer computing system 22 is typically adjustable by the customer 20.

In optional step 412, the delivery agent computing device 44 determines whether the lock 19 is closed, executing a wait loop until the lock 19 is closed. The delivery agent computing device 44 may receive a signal from the lock 19 when the lock is closed. In optional step 414, the delivery agent computing device 44 transmits the day and time that the lock 19 is closed to the lock 19 and/or the business computer. As discussed above, the responsibility for date and time tracking can belong to the client computing system 22.

In optional step 416, the delivery agent computing device 44 transmits the inventory, price list, and/or invoice to the lock 19 via the appropriate interface 62, 72-78. The delivery agent computing device operating method 400 terminates in step 418.

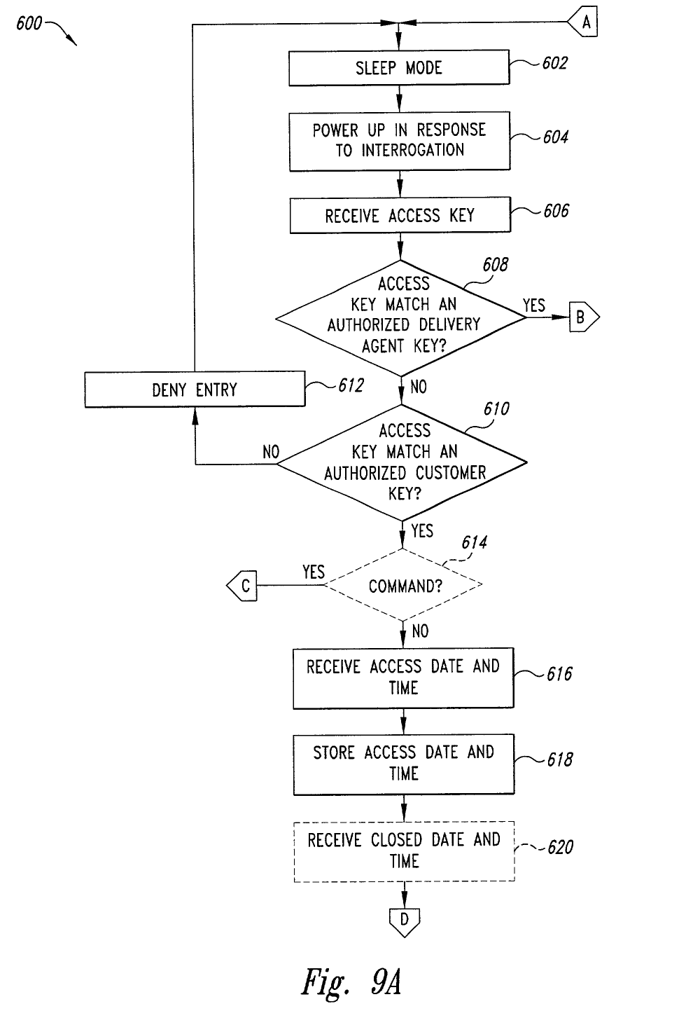

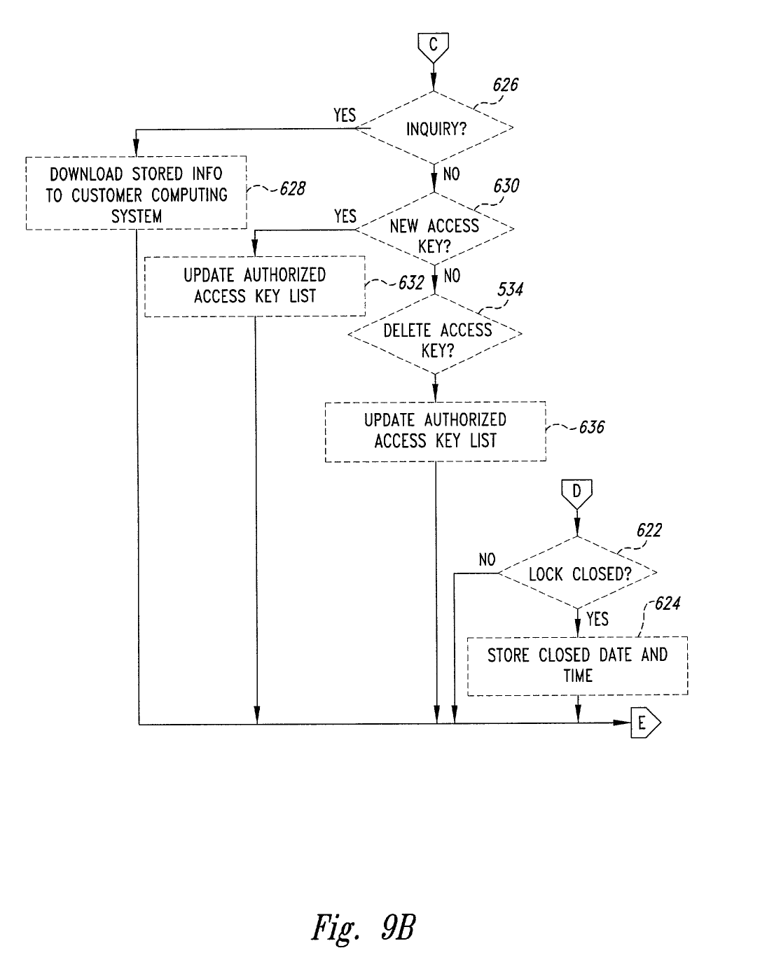

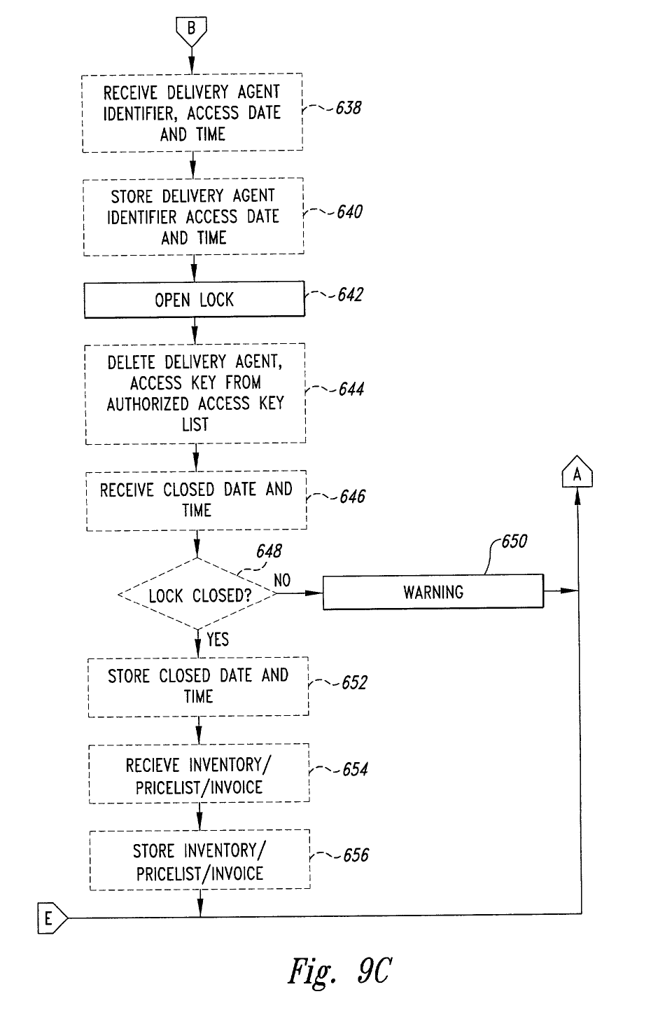

FIGS. 9A-9C show a method 500 of operating a lock 19 having an RFID portion 60, starting in a sleep mode 602. In the sleep mode, the RFID portion expend little or no energy. For example, a passive RFID tag relies on the interrogation signal for energy, and otherwise does not expend energy. The lock 19 powers up in step 604 in response to an interrogation signal received from the delivery agent computing device 44, customer access device 46, or customer computing system 22. In step 606, the lock 19 receives an access key, which may be part of the interrogation signal.

In step 608, the logic 64 determines if the received access key matches an authorized delivery agent access key. If received access key does not match an authorized delivery agent access key, the logic 64 passes control to step 610. If the received access key matches an authorized delivery agent access key, the logic 64 passes control to step 638.

In step 610, the logic 64 determines if the received access key matches an authorized customer access key. If the received access key does not match an authorized customer access key, the logic 64 denies entry in step 612, and returns to the sleep mode 602. If the received access key does not match an authorized customer access key, the logic 64 passes control to step 614.

In step 614, the logic 64 determines whether the interrogation signal includes a command. If the interrogation signal does not include a command, the logic passes control to step 616. If the interrogation signal includes a command, the logic passes control to step 626.

In step 616, the lock 19 receives the access date and time. In step 618, the logic 64 stores the access date and time. In optional step 620, the lock receives the closed date and time. In optional step 622, the logic determines whether the lock is closed. If the lock is not closed the logic returns the RFID portion 60 to sleep mode 602. If the lock is closed, the logic stores the closed date and time in step 624 and returns the RFID portion to sleep mode 602.

In step 626, the logic 64 determines whether the interrogation is an inquiry. An inquiry is likely to be from the customer computing system 22, for example requesting information stored at the lock 19 such as an inventory, price list, invoice, or access information. If the interrogation is an inquiry, the logic 64 downloads the stored information to the customer computing system 22 in step 628 and enters the sleep mode 602. If the interrogation is not an inquiry, the logic 64 passes control to step 630.

In step 630, the logic 64 determines whether the interrogation is a command to add a new authorized access key. If the interrogation is a submission of a new authorized access key, the logic 64 updates the authorized access key list 68 in step 632, and enters the sleep mode 602. If the interrogation is not a submission of a new authorized access key, the logic 64 passes control to step 634.

In step 634, the logic 64 determines whether the interrogation is a command to delete an authorized access key. If the interrogation is a command to delete an authorized access key, the logic 64 updates the authorized access key lost 68 in step 636 and enters the sleep mode 602. If the interrogation is not a command to delete an authorized access key, the logic 64 causes the RFID portion 60 of the lock 19 to enter the sleep mode 602.

In optional step 638, the lock 19 receives the delivery agent identifier, access date and time from the delivery agent computing device 44. In step 640, the logic 64 stores the delivery agent identifier, access date and time to memory 66. In step 642, the logic sends a signal to the actuator 70 to open the lock 19.

In optional step 644, the logic 64 automatically deletes the delivery agent access key from the list of authorized access keys 66, thus terminating further access using that delivery agent access key. This prevents an unscrupulous delivery agent from later using the delivery agent access key to pilfer from the secured area 16, 18.

In optional step 646, the lock 19 receives the closed time and date from the delivery agent computing device 44. In step 648, the logic 64 determines whether the lock 19 is closed. If the lock 19 is not closed, the logic 64 produces a warning in step 650 before returning to the sleep mode 602. If the lock 19 is closed, the logic 64 stores the closed date and time to the memory 66 in step 652.

In optional step 654, the lock 19 receives the inventory, price list and/or invoice from the delivery agent computing device 44. In optional step 656, the logic 64 stores the received the inventory, price list and/or invoice in the memory 66, and returns to the sleep mode 602.

Thus, by controlling access via an RFID device, the customer can pass a delivery agent access key to the business and/or delivery agent, which grants one time access to the secured area 16, 18. If access were granted (i.e., the delivery agent access key matches an authorized access key set by the owner), the particular delivery agent access key may be automatically disabled.

As explained above, RFID provides a means to only power the access when needed, since the RFID device only powers up when a transmitter is nearby. It would only signal the access approval if the transmitted access key matched an authorized access key. The RFID device could record who was granted access and when. Additionally, because the RFID device is programmable, the access key can be changed, or multiple access keys can be enabled. Finally, because the key can be changed, the owner can encrypt the access key and prevent unwanted access by anyone not authorized. For example, the owner may have requested a delivery, and the request could be coupled with a transmission of the delivery agent access key to enable the supplier to complete the delivery. Other devices could be used to transmit the access key, but they require the site to have power to receive the access key. Use of an RFID device allows the secured area remain unpowered until needed, extending battery life, or reducing the additional electronics overheads.

When a transaction is requested by a customer, and then during the process a delivery agent access key is provided, linking an entire transaction. For example, once accounts are established, one could combine account billing and key transmission transaction into a single “Deliver It” button or icon 30 (FIG. 1). The customer would not have to know what the delivery agent key is, or even that a delivery agent access key is generated. The act of selecting the Deliver It button or icon, would automatically transmit the appropriate delivery agent access key to the business or delivery agent, and also transmit the delivery agent access key to the lock (i.e., authorizing the delivery agent access key).

If the account was not billed until the delivery was completed, for example as registered by the lock 19 being opened by the delivery agent 42, one gets closure from both sides of the transaction. The opening of the lock 19 may be transmitted back to the customer computer system 22 enable the sending of the customer's account number to the accounts payable department of the business. Thus, the customer would not be billed if the delivery was not made. The business or delivery company would have a record of making a delivery stop. The business could transmit the inventory delivered and a detailed price list when the lock 19 was accessed or when the account was paid. If the delivery agent 42 had a mobile/wireless Internet connection, these transactions could occur in near real time. Alternatively, the inventory list could be loaded into the RFID device to be downloaded to the customer computing system 22 at a later time, such as when the customer 20 opened the lock 19 to remove the delivered contents.

An RFID interface allows the access to be granted only after successful transmission of an authorized access key. In one sense, no visible electronics would be required. A secured area such as a delivery box 16 would appear uninteresting to would be thieves, because there is no easy access, without destroying the delivery box 16. The transaction begins with a customer buying a product, for example over the Internet 14. This transaction can employ a secure transmittal of the customer's Visa, bank card, etc. At the same time, the customer computing system would pass along a secure delivery agent access key, that the delivery agent 42 would use to gain access to the door 17 of a delivery box 16. The delivery agent 42 would have preferably have a portable delivery agent computing device 44 equipped with an RFID transceiver which would enable the delivery agent 42 to open the delivery box 16 and deliver the product. A keypad, serial link, or wireless link could also accomplish a similar function and could be provided as a means for a delivery agent 42 without an RFID transceiver to perform the delivery.

Similar arrangements could be made between larger customers/suppliers in their management of access to their delivery docking areas. Stores and delivery drivers have systems like DEX/UCS and other mechanisms to allow the delivery driver to pass information to the store on what was delivered, what was returned, what was ordered for the next day. If the delivery agent did not have the correct access key (RFID or not), he could not access the store computer to complete his transaction, or in some cases not be allowed into the delivery area without supervision.

By supplying solutions that connect with a mobile delivery agent computing device 44 to the secure area 18 or delivery box 16, this embodiment helps close the loop in the entire supply chain. Direct home delivery of products is a very fast growing business segment. This embodiment ties the delivery requests with the delivery completion as part of an overall supply chain management problem. This embodiment may close a loop in the supply chain to allow delivery of products to secure locations without requiring an attendant to be present to give access to the site. This embodiment can consist of two pieces. First, is a lock 19 with an electronic key, which is controlled through an RFID interface 62. The lock 19 could have alternative control interfaces, such as a keypad interface 74, wired link interface 76, or wireless link interface 78 to a mobile computer as a means to enable multiple existing technologies to provide the necessary access. These options may increase the cost and complexity of the lock 19, but would increase the range of interface devices, with could have access to it. RFID interface 62 has the potential of being a very cost-effective, low power, secure interface.

The second part consists of an automated way to pass to the delivery agent 42 a secure electronic key at the time of the request to deliver the product. This key would be secure, encrypted perhaps, prior to transmission. The lock 19 would receive a similar transmission. The transmission of the key would occur over any media using applicable technology to transmit data (Internet, modem, cell phone, etc.). The delivery agent 42 would have to transmit the open lock request to the lock 19 to gain access. The delivery agent 42 would then download the contents of the delivery into the lock's electronics or transmit the contents back to the customer computing system 22 directly. The customer computing system would then authorize payment, and close the transaction.

The lock 19 consists of a device to receive communication from the mobile delivery agent computing device 44 that the delivery agent 42 carries. Where the lock 19 include an RFID tag built into it, the power it requires waiting for the delivery agent 42 to arrive can be zero. The RFID tag portion 60 wakes when an RFID transceiver 56, 58 in the delivery agent computing device 44 accesses it and then the logic 64 of the RFID portion 60 either triggers the lock or activates other circuitry to perform that function. The transceiver 56, 58 would transmit the delivery agent's ID, time of access, time of closure, and any other information, such as the items delivered and an invoice to the RFID tag portion 60 for retrieval by the customer 20. When the customer 20 transmits the customer access key, the contents of the RFID tag portion 60 could be downloaded and the account number to invoice could be automatically transmitted to the business. Alternatively, at the time of delivery, the delivery agent computing system 44 could transmit the delivery data back to the customer computing system 22 and billing could be authorized.

The transaction would preferably employ at least two access keys. The first is the customer access key and the second is the delivery agent access key. The customer access key and the delivery agent access key could be the same, but probably would be different secure codes. In this fashion, the customer's access rights can be separate from the delivery agent's access rights.

The transaction can begin with a customer computing system 22 transmitting the customer access key and the delivery agent access key to the lock 19. This transmission from the customer computing system 22 to the lock 19 is either wired (i.e., serial, USB) or wireless (Bluetooth, Picolink, LAN, IR). The transmission could also occur through an RFID transceiver, assuming the customer 20 had one. Since the assumption is the customer 20 is a consumer, the minimum capital expense should be maintained in the lock 19. The other technologies can be readily available to the customer via the standard, current or further available personal computer. The transaction from the customer computing system 22 must be able to wake the electronic lock 19, so the appropriate technology to monitor the interface must be part of ht electronic lock assembly 19. This would be very lower power circuitry, which could be battery powered, The mechanical aspects of the lock 19 must be such that if power is removed, the lock is engaged. Only when power is enabled, can the lock 19 be opened. Once the transaction was enabled, the electronic lock 19 would activate and then power itself down.

The next transaction would be from the delivery agent 42. The delivery agent computing device 44 is preferably equipped with an RFID transceiver 56 to access the RFID portion 60 in the lock 19. The RFID portion 60 would determine if the received access key was valid and then enable the support electronics to power up, and to open the lock 19. The delivery agent computing device 44 could also transmit the time of the delivery, the agent's ID and the time the lock 19 was closed (so that the delivery agent 42 could not say a delivery was complete while keeping, and then report the lock 19 would not engage and that someone else stole the product). In an alternative embodiment, instead of using an RFID portion 60, the delivery agent computing device 44 could access the same port that the customer computing device 22 uses to communicate with the lock 19. Since the lock 19 may have the ability to power up upon activity on this port, a similar means may be used for the delivery agent 42 to access the lock 19 and transmit the access key through this medium. The opportunity to support varied mechanisms to transmit the access key to the lock 19 is viewed as a vehicle to drive multiple user selectable options. Availability of power, security needs, weatherproofing requirements, etc. will dictate which communication mechanism is most attractive. The lock 19 may provide the billing account information after the lock 19 is closed. Again, this is a feature that provides multiple paths to close the transaction.

The next transaction occurs between the customer computing device 22 and the lock 19. When the customer 20 returns to access what has been delivered, the customer computing device 22 or customer access device 46 sends a wake up interrogation signal to the lock 19 and transmits the customer access key. The lock 19 wakes, opens, and allows the customer 20 to access what was delivered. Once the lock 19 has responded to the customer access key, and verifies that it has opened, the lock can then inform the business computing system 26 that the transaction is complete. If so desired, the customer computing system 22 can then send the billing information to the delivery company. As noted before, there are other opportunities to collect the billing information from the customer 20. This last method is the most secure, since the customer has gained access to the secure area 16, 18. If the list of contents of the delivery were transferred to the electronic lock 19, the lock 19 can post this list to the customer computing system 22 so the customer 20 can review the invoice. Another opportunity exits to allow the customer to approve the invoices, prior to transmission of billing information.

The connection between the delivery agent computing device 44 and the electronic lock 19 can be the same one as used by the customer computing system 22, in another embodiment. The connection between the customer computing system 22 and the business could be a phone line, Internet interface, wireless interface, etc. The mobile delivery agent computing device 44 could operate in a batch mode, and not require WAN connections to complete the transaction, as long as the delivery agent access key was provided to the delivery agent computing device.

Background information and/or further details for certain aspects of the above embodiments may be found in U.S. Provisional Patent Application No. 60/205,782, filed May 19, 2000, entitled “WIRELESS DATA COLLECTION METHOD SNA DSYSTEMS, SUCH AS FOR RADIO FREQUENCY (RFID) TAGS” (Attorney Docket No. 11041-8286); U.S. Pat. Nos. 5,536,924; 5,659,431; and 6,056,199, and U.S. patent application Ser. Nos. 09/085,532; 09/050,623; 09/082,427; 09/249,359; and 09/193,281, particularly with respect to systems and methods for reading and printing machine-readable symbols and RF tags; U.S. Pat. No. 5,440,315, entitled “Antennae Apparatus for Capacitively Coupling an Antennae Ground Plane to a Movable Antenna,” issued Aug. 8, 1995, particularly with respect to antennas, U.S. patent application Ser. Nos. 09/173,539, 09/164,203, 09/164,200 and 09/280,287, filed Oct. 15, 1998, Sep. 30, 1998, Sep. 30, 1998 and Mar. 29, 1999, all respectively, with respect to manufacturing RFID tags and composition of such tags; U.S. Pat. Nos. 5,592,408, 5,625,349, 5,541,581 and 5,745,044, with respect to security systems; 5,737,710, 5,874,902, 5,310,999, 5,629,981, and 5,548,106, particularly with respect to preventing unauthorized use of tags and toll or credit-collection reporting systems; U.S. Pat. Nos. 5,959,568, and 4,728,955, particularly with respect to RFID tags and signals exchange therewith.

The above description of illustrated embodiments of the invention is not intended to be exhaustive, or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other automated data collection systems and methods, not necessarily the systems described above.

The various embodiments described above can be combined to provide yet further embodiments. All of the above references and U.S. patents and applications are incorporated herein by reference. Aspects of the invention can be modified, if necessary to employ the systems, functions and concepts of the various patents and applications of described above to provide yet further embodiments of the invention.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A delivery system, comprising:
a secured area having an entrance;
a lock securing the entrance to the secured area and responsive to at least a first delivery agent access key to provide access to the secured area;
a customer communications device configured to place requests for at least one of goods and services and to transfer the first delivery agent access key;
a business communications device configured to receive the requests and the first delivery agent access key transferred from the customer communications device; and
a handheld delivery agent communications device configured to transmit the first delivery agent access key to the lock to access the secured area.

2. The delivery system of claim 1 wherein the delivery agent communications device includes a wireless radio frequency interrogator to transmit the first delivery agent access key to the lock.

3. The delivery system of claim 1 wherein the lock includes a wireless radio frequency receiver to receive the first delivery agent access key from the delivery agent communications device.

4. The delivery system of claim 1 wherein the lock includes a passive wireless radio frequency receiver to receive the first delivery agent access key from the delivery agent communications device.

5. The delivery system of claim 1 wherein the customer communications device includes a computer.

6. The delivery system of claim 1 wherein the customer communications device includes a telephone.

7. The delivery system of claim 1 wherein the secured area is one of a delivery box, a customer home, a porch of the customer home, and a garage of the customer home.

8. The delivery system of claim 1 wherein business communications device comprises:
a Web Server;
a set of Web pages for transmission by the Web server; and
a database of order information.

9. The delivery system of claim 1 wherein customer communications device comprises:
a Web client; and
a display for displaying Web pages retrieved by the Web client.

10. A customer delivery system, comprising:
a lock for securing an entrance to a secured area, the lock responsive to at least a first customer access key and to at least a first delivery agent access key to provide access to the secured area; and
a customer communications device selectively couplable to a business to transfer the first delivery agent access key and a request for at least one of goods and services to the business, the customer communications device also couplable to the lock to set at least the first delivery agent access key to a defined value different from a defined value of the first customer access key and other delivery agent access keys and customer access keys.

11. The customer delivery system of claim 10 wherein the lock comprises:
a passive radio frequency identification receiver coupled to provide produce a signal in response to a match between the first delivery agent access key and a set of authorized access keys;
a securing member; and
an actuator responsive to the signal produced by the passive radio frequency identification receiver and coupled to move the securing member between a locked position and an unlocked position for alternatively securing and providing access to the secured area.

12. The customer delivery system of claim 10 wherein the customer communications device comprises:
a computer; and
a modem coupled to the computer to transmit information to and from the computer.

13. The customer delivery system of claim 10 wherein the customer communications device comprises:
a computer couplable to the lock to provide a set of authorized access keys and programmed to select the defined value of the first delivery agent access key; and
a modem coupled to the computer to transmit the first delivery agent access key and the request from the computer to the business.

14. A business delivery system, comprising:
a business communications device selectively couplable to receive a delivery agent access key and a request for at least one of goods and services from a customer communication device; and
a delivery agent communications device couplable to transfer the delivery agent access key to a lock to gain access to a secure area.

15. The business delivery system of claim 14 wherein business communications device comprises:
a Web server;
a set of Web pages for transmission by the Web server; and
a database of order information.

16. The business delivery system of claim 14 wherein the delivery agent communications device further comprises:
at short range antenna;
a short range transmitter portion coupled to the short range antenna to transmit the delivery agent access key to the lock;
a long range antenna;
a long range transmitter portion; and
a long range receiver portion, the long range transmitter and receiver portions each coupled to the long range antenna to provide real-time communications between the business communications device and the delivery agent communications device.

17. A method of facilitating the delivery of goods and services, comprising:
receiving a request for at least one of goods and services;
receiving a first delivery agent access key;
entering the first delivery agent access key into a lock controlling access to a secured area;
gaining access to the secured area; and
delivering the requested goods and services to the secured area.

18. The method of claim 17, further comprising:
providing at least one of an identifier corresponding to an identity of a delivery agent; a date and time that access to the secured area was gained, and a date and time that access to the secured area was terminated.

19. The method of claim 17, further comprising:
providing at least one of an invoice and a price list of the delivered goods and services to a customer requesting the goods and services.

20. The method of claim 17, further comprising:
transmitting a confirmation of the delivery of the goods and services following the delivering of the requested goods and services.

21. The method of claim 17, further comprising:
automatically forwarding a billing statement to a customer for the delivered goods and services following the delivering of the requested goods and services.

22. The method of claim 17, further comprising:
automatically debiting an account belonging to a customer for the delivered goods and services following the delivering of the requested goods and services.

23. The method of claim 17, further comprising:
transmitting at least one Web page including a list of available goods and services.

24. The method of claim 17 wherein entering the first delivery agent access key into a lock comprises:
transmitting a radio frequency signal encoding the first delivery agent key to a receiver of the lock.

25. A method of facilitating the delivery of goods and services, comprising:
transmitting a request for at least one of goods and services to a business;
transmitting a first delivery agent access key to the business; and
configuring a lock controlling access to a secured area to provide access to the secured area in response to receipt of at least the first delivery agent access key.

26. The method of claim 25, further comprising:
receiving a radio frequency signal encoding the first delivery agent key.

27. The method of claim 25, further comprising:
receiving the first delivery agent access key;
providing access to the secured area in response a match between the received first delivery agent access key and a set of authorized access keys; and
receiving at least one of the requested goods and services to the secured area.

28. The method of claim 25, further comprising:
receiving the first delivery agent access key;
providing access to the secured area in response a match between the received first delivery agent access key and a set of authorized access keys;
receiving at least one of the requested goods and services to the secured area; and
removing the first delivery agent access key from the set of authorized access keys after providing access to the secured area.

29. The method of claim 25, further comprising:
receiving the first delivery agent access key;
providing access to the secured area in response a match between the received first delivery agent access key and a set of authorized access keys;
receiving at least one of the requested goods and services to the secured area;
recording at least one of a day and a time that access to the secured area was provided based on the first delivery agent access key;
removing the first delivery agent access key from the set of authorized access keys after providing access to the secured area;
receiving a first customer access key from a customer;
providing access to the secured area in response a match between the received first customer access key and a set of authorized access keys; and
recording at least one of a day and a time that access to the secured area was provided based on the first customer access key.

30. The method of claim 25 wherein transmitting a request for at least one of goods and services comprises:
transmitting an HTTP request from a Web client to a Web server using a method attribute set to at least one of a POST and a GET.

31. The method of claim 25, further comprising:
configuring the lock controlling access to the secured area to provide access to the secured area in response to at least a second access key, different than the delivery agent access key.

32. The method of claim 25 wherein configuring a lock controlling access to a secured area to provide access to the secured area in response to at least the first delivery agent access key includes setting an expiration date and a time for the first delivery agent access digital key.

33. The method of claim 25, further comprising:
recording at least one of an identifier corresponding to an identity of a delivery agent; a date and time that access to the secured area was provided, and a date and time that access to the secured area was terminated.

34. The method of claim 25, further comprising:
automatically receiving at least one of an invoice and a price list of the delivered goods and services to a customer requesting the goods and services.

35. The method of claim 25, further comprising:
automatically receiving a confirmation of the delivery of the goods and services following the delivering of the requested goods and services.

36. The method of claim 25, further comprising:
encrypting the first delivery agent access key before transmitting the first delivery agent access key.

37. An automated ordering method, comprising:
displaying information identifying at least one of goods and services available for order;
in response to a single action transmitting a request for at least a selected one of the goods and services along with a delivery agent access key for gaining access to a secure area;

38. The automated ordering method, further comprising:
in response to the single action transmitting the delivery agent access key to a lock securing the secured area.

39. A client system for ordering goods and services, comprising:
a display component for displaying information identifying goods and services available for order; and
a single-action ordering component that in response to a performance of a single action, sends a request to a server system to order at least a selected one of the available goods and services, the request including a delivery agent access key for gaining access to a secure area.

40. The client system of claim 39 wherein the single-action ordering component in response to the performance of the single action, also sends the delivery agent access key to a lock securing the secured area.
